(19) United States
(12) Patent Application Publication
(10) Pub. No.: US 2025/0296134 A1
(43) Pub. Date: Sep. 25, 2025

(54) POUCH FORMING APPARATUS INCLUDING VACUUM PAD AND POUCH FORMING METHOD

(71) Applicant: SK On Co., Ltd., Seoul (KR)

(72) Inventors: Taek Eon JEONG, Daejeon (KR); Jae Gyu BYUN, Daejeon (KR); Seung Won CHOI, Daejeon (KR)

(21) Appl. No.: 19/028,715

(22) Filed: Jan. 17, 2025

(30) Foreign Application Priority Data
Mar. 21, 2024 (KR) 10-2024-0039259

(51) Int. Cl. B21D 22/22; H01M 50/105

(52) U.S. Cl. CPC B21D 22/22; H01M 50/105

(57) ABSTRACT

A pouch forming apparatus includes a die portion having a forming groove, a punch portion disposed to face the forming groove and configured to move relative to the forming groove, and pressurizing a pouch sheet disposed on the die portion into the forming groove, a forming pad disposed to move relative to the punch portion within the forming groove and controlling a depth of the forming groove, and a vacuum pad applying vacuum pressure to the forming groove to be in close contact with the pouch sheet. The vacuum pad is disposed in at least one corner area of the forming pad.

### CROSS-REFERENCE TO RELATED APPLICATION(S)

This patent document claims the priority and benefits of Korean Patent Application No. 10-2024-0039259 filed on Mar. 21, 2024, the disclosure of which is incorporated herein by reference in its entirety.

### TECHNICAL FIELD

The disclosure and implementations disclosed in this patent document generally relate to a pouch forming apparatus including a vacuum pad and a method of forming a pouch.

### BACKGROUND

Secondary batteries, unlike primary batteries, have the convenience of being able to be charged and discharged, and are thus receiving significant attention as power sources for various mobile devices and electric vehicles.

Such secondary batteries may include battery cells in which an electrode assembly formed by stacking a positive electrode plate, a negative electrode plate, and a separator or by being wound in a roll shape is accommodated inside a case. A plurality of battery cells may be stacked in a predetermined direction and accommodated in a battery module or battery pack.

Meanwhile, battery cells may be classified into pouch-type, prismatic-type, or cylindrical-type battery cells, depending on the type of case in which the electrode assembly is accommodated.

In this case, the case of the pouch-type battery cell may be manufactured by a deep drawing method in which an external pouch material is pressed against a groove of a pre-made mold with a punch to form an elongated shape. Therefore, a cup portion in which the electrode assembly is accommodated may be formed.

However, if the pouch sheet is elongated beyond a certain depth in the groove of the mold, problems such as cracks or wrinkles occurring in the pouch case or tearing may occur due to limitations in the outer material restraint.

### SUMMARY

The present disclosure may be implemented in some embodiments to provide a pouch forming apparatus capable of significantly reducing cracking or breaking of a pouch sheet.

According to an aspect of the present disclosure, a pouch forming apparatus capable of significantly increasing an elongation size of a pouch sheet may be provided.

According to an aspect of the present disclosure, a pouch forming apparatus for manufacturing a pouch case for improving energy efficiency may be provided.

In some embodiments of the present disclosure, a pouch forming apparatus includes a die portion having a forming groove; a punch portion disposed to face the forming groove and configured to move relative to the forming groove, and pressurizing a pouch sheet disposed on the die portion into the forming groove; a forming pad disposed to move relative to the punch portion within the forming groove and controlling a depth of the forming groove; and a vacuum pad applying vacuum pressure to the forming groove to be in close contact with the pouch sheet. The vacuum pad is disposed in at least one corner area of the forming pad.

The forming pad may include a plurality of edge portions, and at least one corner portion provided between the plurality of edge portions and disposed in the corner area, and the vacuum pad may be disposed adjacent to the at least one corner portion.

The forming pad may divide the forming groove into a first space into which the pouch sheet is introduced and formed a second space into which the pouch sheet is not introduced. The vacuum pad may provide vacuum pressure to the first space so as to be in close contact with a corner area of the pouch sheet corresponding to a corner area of the vacuum pad.

The vacuum pad and the forming pad may each include an upper surface which faces the punch portion and on which the pouch sheet is seated, and the upper surface of the vacuum pad may be disposed parallel to the upper surface of the forming pad or may be disposed lower than the upper surface of the forming pad.

The vacuum pad may be inserted into the forming pad, to be exposed to the forming groove through the upper surface of the forming pad.

The pouch forming apparatus may further include a vacuum device disposed outside the forming groove and forming a vacuum pressure; and a vacuum line connecting the vacuum device and the vacuum pad and providing the vacuum pressure to the vacuum pad. The vacuum line may penetrate at least one of a forming lower surface or a forming side surface of the die portion forming the forming groove and may be connected to the vacuum device.

The forming pad may be provided to move so that a relative distance to the punch portion changes while being raised and lowered in the forming groove, and the vacuum pad may be provided to be in close contact with a corner area of the pouch sheet corresponding to the corner area of the forming pad.

The forming pad may be provided to extend the corner area of the pouch sheet while moving in a direction in which the relative distance from the punch portion increases in a state in which the corner area of the pouch sheet and the vacuum pad are in close contact.

The punch portion may be provided to bring the pouch sheet into close contact with the forming pad while moving in a direction in which a relative distance from the forming pad decreases in a state in which the corner area of the pouch sheet is extended. The vacuum pad may be provided to continuously provide vacuum pressure so as to be in close contact with the corner area of the pouch sheet.

In some embodiments of the present disclosure, an apparatus for forming a pouch includes a die portion having a forming groove and with a pouch sheet disposed thereon; a punch portion provided to move relative to the forming groove, to be at least partially inserted into the forming groove; a forming pad provided to be raised and lowered within the forming groove and dividing the forming groove into a first space in which the forming groove is introduced and formed and a second space in which the forming groove is not introduced, and providing a lower surface of the first space; and a vacuum pad applying vacuum pressure to the first space so that the pouch sheet is introduced into and adhered to the first space. The vacuum pad is disposed at a corner area of the forming pad so that the pouch sheet adheres to the corner area of the forming pad. The forming pad is provided to elongate the pouch sheet while moving in a direction in which a depth of the first space increases in a state in which the pouch sheet is adhered to the corner area of the forming pad.

In some embodiments of the present disclosure, a method of forming a pouch includes a first forming process of closely attaching a pouch sheet to a forming pad disposed inside a forming groove and elongating the pouch sheet by lowering the forming pad; and a second forming process in which a punch portion disposed to face an upper portion of the forming pad is lowered into the forming groove and pressurizes the pouch sheet against the forming pad. The first forming process includes a first operation of pressing the pouch sheet against a corner area of the forming pad by a vacuum pad disposed at the corner area of the forming pad and forming a vacuum pressure; and a second operation in which the forming pad moves away from the punch portion to elongate a corner area of the pouch sheet corresponding to the corner area of the forming pad.

In the above, the solution according to the present disclosure is described, but this is illustrative, and it should be understood that other configurations not mentioned are also included in the present disclosure.

### BRIEF DESCRIPTION OF DRA WINGS

Certain aspects, features, and advantages of the present disclosure are illustrated by the following detailed description with reference to the accompanying drawings.

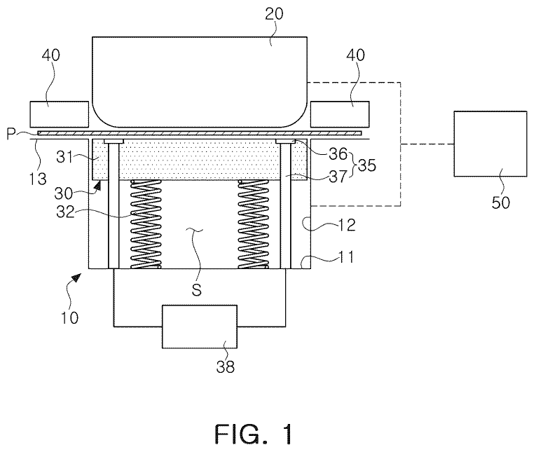

FIG. 1 is a schematic diagram of a pouch forming apparatus according to an embodiment.

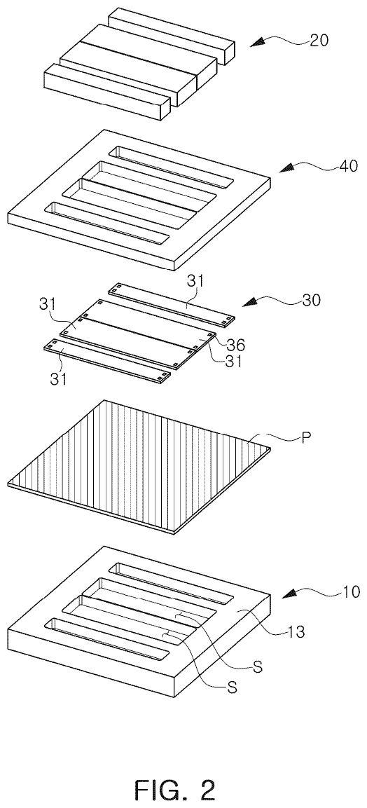

FIG. 2 is a schematic exploded perspective view of a pouch forming apparatus according to an embodiment.

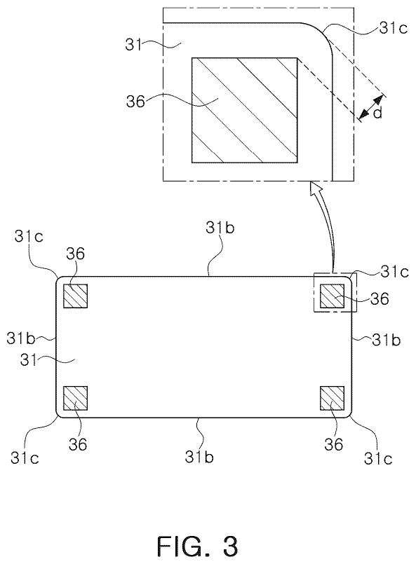

FIG. 3 is a plan view of a forming pad according to an embodiment.

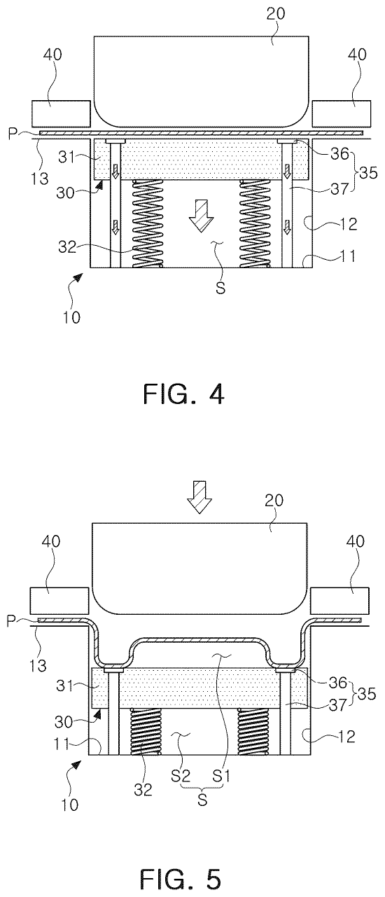

FIG. 4 and FIG. 5 are schematic diagrams illustrating a process of forming a pouch sheet using a vacuum pad according to an embodiment.

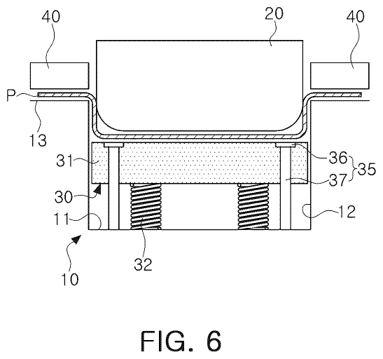

FIG. 6 is a schematic diagram illustrating a process of forming a pouch sheet using a punch portion according to an embodiment.

### DETAILED DESCRIPTION

Features of the present disclosure disclosed in this patent document are described by example embodiments with reference to the accompanying drawings.

Prior to the detailed description of example embodiments, terms or words used in the descriptions below and claims should not be construed as being limited to their usual or dictionary meanings, and should be interpreted with meaning and concept consistent with the technical idea of the present disclosure, based on the principle that the inventor may appropriately define the concept of terms to explain his or her invention in the best way.

The same reference numbers or symbols in respective drawings indicate parts or components performing substantially the same function.

In the following description, singular expressions include plural expressions unless the context clearly dictates otherwise. Terms such as “include,” “configure” and the like are intended to designate the presence of features, numbers, steps, operations, components, parts, or combinations thereof described in the specification, and should be understood as not precluding the presence or addition of one or more other features, numbers, steps, operations, components, parts, or combinations thereof.

In addition, in the following description, expressions such as upper side, upper portion, lower, bottom, side, front, rear, and the like are expressed based on the direction illustrated in the drawing, and it should be noted in advance that if the direction of the object is changed, it may be expressed differently.

Additionally, in the descriptions below and claims, terms including ordinal numbers such as “first,” “second,” and the like may be used to distinguish between components. These ordinal numbers are used to distinguish identical or similar components from each other, and the meaning of the term should not be interpreted limitedly due to the use of these ordinal numbers. For example, components combined with these ordinal numbers should not be interpreted as having a limited order of use or arrangement based on the number. If necessary, respective ordinal numbers may be used interchangeably.

Hereinafter, a pouch forming apparatus according to an embodiment will be described with reference to the drawings.

FIG. 1 is a schematic diagram of a pouch forming apparatus according to an embodiment, and FIG. 2 is a schematic exploded perspective view of a pouch forming apparatus according to an embodiment. Meanwhile, although a pouch sheet P used in the present disclosure is also illustrated in the drawings, this is illustrated together for convenience of understanding, and the pouch forming apparatus of the present disclosure may not include the pouch sheet P.

Referring to FIGS. 1 and 2, a pouch forming apparatus according to an embodiment may include a die portion 10 having a forming groove S, a punch portion 20 positioned to face the die portion 10 and to move relative to the forming groove S while introducing a pouch sheet P into the forming groove S, a forming support portion 30 including a forming pad 31 positioned in the forming groove S and capable of supporting the punch portion 20, and a vacuum forming portion 35 forming a vacuum in the forming groove S.

In addition, according to an embodiment, the pouch forming apparatus may include a vacuum device 38 communicating with the vacuum forming portion 35 and a control portion 50 connected to at least one of the die portion 10, the forming pad 31, or the vacuum forming portion 35 to control the same. In addition, according to an embodiment, a stripper 40 may be included to secure the pouch sheet P to a mounting surface 13.

The pouch sheet P may be an outer material forming a case of a secondary battery, for example, a battery cell. The pouch sheet P may be formed into a predetermined shape corresponding to a forming groove S to form a cup portion in which an electrode assembly may be accommodated. As the depth of the cup portion increases during the forming of the pouch sheet P, a larger electrode assembly may be accommodated in the pouch case, thereby increasing the energy efficiency of the battery cell. However, as the depth of the cup portion increases, the elongation size of the pouch sheet P, which is an outer material of the case, increases, causing cracks to occur, and thus there is a limit to increasing the elongation size of the pouch sheet P. According to an embodiment of the present disclosure, during the elongation forming of the pouch sheet P, the elongation size of the pouch sheet P may be further increased, and as a result, a case for a battery cell with a larger capacity may be provided.

The die portion 10 may include forming inner surfaces 11 and 12 forming a forming groove S and a mounting surface 13 which is disposed around the forming groove S and on which the pouch sheet Pis mounted. In FIG. 2, a plurality of the forming grooves S are illustrated so that a plurality of cup portions may be formed with one pouch sheet P, but this is only for the convenience of understanding, and the present disclosure is not limited thereto. In detail, even if at least one forming groove S is formed, it should be considered that they all belong to the present disclosure.

The forming groove S may refer to a space formed by the forming lower surface 11 and the forming side surface 12 by the die portion 10 sinking inward. The pouch sheet P may be formed by being introduced into the forming groove S by the punch portion 20 or the vacuum forming portion 35 described later.

The mounting surface 13 may refer to the upper surface of the die portion 10 extending from the forming side surface 12 to the edge of the forming groove S. The mounting surface 13 may provide a space in which the pouch sheet P is mounted or settled. A stripper 40 may be disposed to face the mounting surface 13.

The stripper 40 may pressurize the pouch sheet P to the mounting surface 13 so that at least a portion of the pouch sheet P facing the forming pad 31 may be introduced into the forming groove S and fixed.

The punch portion 20 is disposed to face the forming groove S and may move in a direction in which the relative distance to the forming groove S changes. The punch portion 20 is provided in a shape corresponding to the forming groove S and may move so that at least a portion thereof is inserted into the forming groove S (see FIG. 6).

The punch portion 20 may press the pouch sheet P disposed on the die portion 10 into the forming groove S so that at least a portion of the pouch sheet P may be introduced into the forming groove S.

The forming support portion 30 may include a forming pad 31 that is disposed in the forming groove S and may move relative to the punch portion 20 and a pad support portion 32 that supports the forming pad 31.

The forming pad 31 may support the pouch sheet P from being formed. For example, the pouch sheet P may be settled on the upper surface (the surface facing the punch portion 20) of the forming pad 31 to obtain the forming. The upper surface of the forming pad 31 may form the lower surface of a first space S1 to be described later.

For example, the shape of the upper surface of the forming pad 31 may determine the shape of the cup portion when the pouch sheet P is formed. In the drawing, the forming pad 31 is depicted as a rectangular solid shape parallel to the forming lower surface 11, but the shape thereof may be formed in various manners depending on the shape of the cup portion required.

The forming pad 31 may support the punch portion 20 so that the pouch sheet P is pressurized when the punch portion 20 is introduced into the forming groove S (see FIG. 6). In addition, a vacuum pad 36 to be described later may be disposed on the forming pad 31 so that the pouch sheet P may be intensively pressed against the corner portion 31c (see FIG. 3) of the forming pad 31. This will be described later.

In addition, the forming pad 31 may divide the forming groove S into a first space S1 and a second space S2 (see FIG. 5). At least portions of the pouch sheet P and the punch portion 20 may be introduced into the first space S1 of the forming groove S so that the forming of the pouch sheet P may be performed. A pad support portion 32 and a vacuum line 37 to be described later may be disposed in the second space S2. In this case, being introduced may mean that the pouch sheet P may be disposed in the first space S1.

The first space S1 is a space in which the pouch sheet P is introduced and the stretching or forming of the pouch sheet P occurs, and may be referred to as an ‘upper space’, and the second space S2 is a space in which the pouch sheet P is not introduced and the pad support portion 32 may be disposed, and may be referred to as a ‘lower space.’

Meanwhile, in this case, ‘dividing the forming groove S into the first space S1 and the second space S2’ does not necessarily mean strictly separating or blocking the two spaces physically, but may mean functionally dividing the forming groove S into a space into which the pouch sheet P is introduced and a space into which the pouch sheet P is not introduced.

For example, the space formed by the upper surface of the forming pad 31 and the forming side surface 12 may be referred to as the first space S1, and the space formed by the lower surface of the forming pad 31, the forming lower surface 11, and the forming side surface 12 may be referred to as the second space S2.

In addition, the forming pad 31 is provided to be able to be raised and lowered in the forming groove S by the pad support portion 32 described below, so that the depth of the forming groove S, in detail, the depth of the first space S1 into which the pouch sheet P is introduced and the forming thereof occurs may be adjusted.

The pad support portion 32 may be disposed in the second space S2 of the forming groove S to support the forming pad 31. For example, the pad support portion 32 may support the forming pad 31 by having one side connected to the lower surface (the surface facing the forming lower surface 11) of the forming pad 31 and the other side connected to the forming lower surface 11.

In addition, the pad support portion 32 may move the forming pad 31 relative to the punch portion 20. In detail, the pad support portion 32 may raise and lower the forming pad 31 in the forming groove S.

When the forming pad 31 is raised and lowered, the depth of the first space S1 and the depth of the second space S2 of the forming groove S may be changed. In detail, when the pad support portion 32 lowers the forming pad 31, the depth of the first space 1 may increase and the depth of the second space S2 may decrease. Conversely, when the pad support portion 32 raises the forming pad 31, the depth of the first space S1 may decrease and the depth of the second space S2 may increase by the amount of decrease.

In this manner, the pad support portion 32 may enable the forming pad 31 to change the depth of the forming groove S (in detail, the first space S1 in which forming occurs). The pad support portion 32 may control the lifting distance or speed of the forming pad 31 by the control member 50.

In addition, before the pouch sheet P is formed, the forming pad 31 may be disposed parallel to the mounting surface 13 of the die portion 10, and for example, may be disposed so that the depth of the second space S2 is approximately the same as the depth of the forming groove S (see FIG. 4). As described below, in this state, the pouch sheet P may be pressed against the corner portion 31c of the forming pad 31 by the vacuum pad 36. However, the present disclosure is not limited thereto.

In addition, the pad support portion 32 may elastically support the forming pad 31 by including an elastic body. For example, the pad support portion 32 may support the forming pad 31 by including an elastic material such as a spring. However, the present disclosure is not limited thereto, and any structure that may support the forming pad 31 belongs to the present disclosure.

The vacuum forming portion 35 may apply vacuum pressure to the forming groove S to form the pouch sheet P. The vacuum forming portion 35 may include a vacuum pad 36 that is disposed on the forming pad 31 and may be in close contact with the pouch sheet P, and a vacuum line 37 that connects the vacuum pad 36 and the vacuum device 38.

The vacuum pad 36 is disposed to be exposed to the upper surface of the forming pad 31 and may apply vacuum pressure to the forming groove S, in detail, the first space S1 of the forming groove S. In this case, ‘exposed’ may refer to a structure in which the vacuum pad 36 is positioned to be in close contact with the pouch sheet P.

For example, the vacuum pad 36 may be inserted into the forming pad 31 so that an upper surface thereof is positioned parallel to the upper surface of the forming pad 31, and the lower surface of the vacuum pad 36 may be provided to be connected to the vacuum line 37 described later to receive vacuum pressure. In detail, the structure may be deformed as long as it is a structure in which the pouch sheet P may be in close contact with the vacuum pad 36 by the vacuum pressure of the vacuum pad 36.

In addition, the upper surface of the vacuum pad 36 may be positioned at a height approximately parallel to or lower than the upper surface of the forming pad 31. In detail, if the upper surface of the vacuum pad 36 protrudes higher than the upper surface of the forming pad 31, the corresponding part may be deformed or broken by the punch portion 20 described later (see FIG. 6). In addition, to improve the adhesion between the vacuum pad 36 and the pouch sheet P, it is advantageous that the upper surface of the vacuum pad 36 is disposed approximately parallel to the upper surface of the forming pad 31.

Meanwhile, the ‘vacuum pressure’ in the present disclosure may mean that the vacuum pad 36 provides a pressure lower than the atmospheric pressure around the surroundings so that air around the upper surface of the vacuum pad 36 is sucked into the vacuum pad 36, and may include negative pressure. For example, the vacuum pad 36 may form a vacuum pressure in the forming groove S so that the pouch sheet Pis sucked into the vacuum pad 36 and adhered thereto.

In detail, the vacuum pad 36 may adhere to the pouch sheet P while sucking the same. As described later in FIGS. 4 and 5, when the pouch sheet P is adhered to the vacuum pad 36 disposed near the corner portion 31c of the forming pad 31, as the forming pad 31 is lowered, the corner portion of the pouch sheet P may be intensively elongated.

In addition, the vacuum pad 36 may include an elastic material that may improve adhesion to the pouch sheet P. For example, the vacuum pad 36 may include rubber formed of Ethylene Propylene Diene Monomer (EPDM).

The vacuum line 37 may be disposed outside the forming groove S to connect the vacuum device 38 that forms vacuum pressure and the vacuum pad 36. The vacuum line 37 may be disposed in the second space S2 to prevent interference with the pouch sheet P. For example, one side of the vacuum line 37 may be connected to the vacuum pad 36 disposed on the forming pad 31, and the other side thereof may be connected to the vacuum device 38 disposed outside the forming groove S by penetrating through the forming lower surface 11 or the forming side surface 12. In addition, the vacuum line 37 may be disposed to penetrate the forming pad 31 as shown in the drawing, but the present disclosure is not limited thereto.

As such, the connection structure of the vacuum line 37 and the vacuum device 38 of the present disclosure is an example, and may be changed in various ways as long as it provides a vacuum pressure to the vacuum pad 36.

FIG. 3 is a plan view of a forming pad 31 according to an embodiment, which is a drawing illustrating the upper surface of the forming pad 31 and a drawing partially enlarged of a corner area of the forming pad 31.

Referring to FIG. 3, the forming pad 31 may be provided in a roughly quadrangular shape corresponding to the shape of the forming groove S and may include four edge portions 31b and four corner portions 31c. The corner portion 31c may be disposed in the corner area of the forming pad 31 (see the partially enlarged drawing of FIG. 3).

Meanwhile, in the present disclosure, a portion adjacent to the edge portion 31b and the corner portion 31c may be referred to as a peripheral area of the forming pad 31, and a portion other than the peripheral area may be referred to as a central area of the forming pad 31.

In detail, the forming pad 31 may include a central area where the edge portion 31b and the corner portion 31c are not disposed, and a peripheral area where the edge portion 31b and the corner portion 31c are disposed. The peripheral area may include a corner area (see the partial enlargement of FIG. 3) where the corner portion 31c is disposed, and an edge area where only the edge portion 31b is disposed without the corner portion 31c.

The pouch forming process may be performed by closely contacting the upper surface of the forming pad 31 with the pouch sheet P by the punch portion 20 (see FIG. 6), and during this process, the stretching of the pouch sheet P may be intensively performed in a portion corresponding to the peripheral area of the forming pad 31. In detail, among the surrounding areas, the corner area (see the partial enlargement of FIG. 3) where the corner portion 31c is disposed may cause the stretching of the pouch sheet P to occur more intensively, and cracks or breakage of the pouch sheet P may occur.

Accordingly, in the present disclosure, the occurrence of cracks or breakage may be significantly reduced in the corner area of the pouch sheet P during the secondary stretching through the punch portion 20 by first intensively elongating the corner area of the pouch sheet P corresponding to the corner area of the forming pad 31 through the vacuum pad 36 prior to the forming process through the punch portion 20.

According to an embodiment, the vacuum pad 36 may be disposed in the corner area of the forming pad 31 (see the partial enlargement of FIG. 3). The vacuum pad 36 may be disposed adjacent to the corner portion 31c in the corner area.

In this case, the meaning of being disposed adjacently may mean that the distance d (hereinafter referred to as “the shortest distance between the corner portion 31c and the vacuum pad 36”) between the corner portion 31c of the forming pad 31 and the closest portion of the vacuum pad 36 satisfies a predetermined range.

For example, the shortest distance between the corner portion 31c and the vacuum pad 36 may be 1 mm to 10 mm. However, this value is only an example to help understanding, and since this value may vary depending on the shape and size of the forming pad 31 and the vacuum pad 36, the size of the pouch sheet P or the like, the present disclosure is not limited thereto.

In addition, ‘the vacuum pad 36 is disposed adjacent to the corner portion 31c’may mean that it is disposed adjacent to both edge portions 31b forming the corner portion 31c. For example, as shown in the partial enlargement (corner area) of FIG. 3, it may be disposed close to both the edge portion 31b disposed above and the edge portion 31b disposed on the right side based on the vacuum pad 36 drawing.

Meanwhile, according to another embodiment, although not shown in the drawing, it may be the vacuum pad 36 corner area. For example, it may be provided in a shape in which a vacuum pad 36 is disposed between the forming pad 31 and the forming side surface 12. For example, it should be understood that any structure for locally applying negative pressure to the corner area of the pouch sheet P belongs to the present disclosure.

Meanwhile, the central area, peripheral area, corner area, and edge area of the forming pad 31 described above may be virtual areas for explaining the arrangement position of the vacuum pad 36. In this way, the present disclosure is not particularly limited to a structure for intensively applying vacuum pressure to the corner area of the pouch sheet P.

Hereinafter, a pouch sheet forming process using the pouch forming apparatus of the present disclosure will be described with reference to FIGS. 4 to 6.

FIGS. 4 and 5 are schematic drawings illustrating a process for forming a pouch sheet using a vacuum pad according to an embodiment, and FIG. 6 is a schematic drawing illustrating a process for forming a pouch sheet using a punch portion according to an embodiment.

The pouch forming apparatus of the present disclosure may form a pouch sheet P through a first forming process and a second forming process. The first forming process is explained through FIGS. 4 and 5, and the second forming process is explained through FIG. 6.

Referring to FIG. 4, the pouch forming apparatus of the present disclosure applies vacuum pressure to a forming groove S through a vacuum forming portion 35. The vacuum pad 36 disposed in the corner area of the forming pad 31 may be in close contact with the pouch sheet P while sucking the corner area of the pouch sheet P. In detail, the vacuum pad 36 is included in the present disclosure if it has a structure that may be in close contact with the peripheral area, in detail, the corner area, rather than the central area of the pouch sheet P.

Referring to FIG. 5, while the vacuum pad 36 is in close contact with the pouch sheet P, the forming pad 31 may be lowered from the forming groove S toward the forming lower surface 11 so that the relative distance to the punch portion 20 increases. For example, as the forming pad 31 is lowered, the depth of the forming groove S, in detail, the depth of the first space S1 where the forming of the pouch sheet P occurs, may be changed.

In this way, the forming pad 31 may be lowered while the vacuum pad 36 is in close contact with the corner area of the pouch sheet P. Among the central area and the peripheral area of the pouch sheet P, the peripheral area, in more detail, the corner area, may be intensively elongated.

In detail, the first forming process may include an operation of pressing the pouch sheet P against the forming pad 31 disposed inside the forming groove S and lowering the forming pad 31 to at least partially extend the pouch sheet P. In addition, the first forming process may include an operation of pressing the pouch sheet P against the corner area of the forming pad 31 through the vacuum pad 36 and an operation of extending the pouch sheet P while the forming pad 31 moves (lowers) away from the punch portion 20.

In detail, the first operation may be an operation (see FIG. 4) in which the peripheral area of the forming pad 31, in more detail, the corner area of the pouch sheet P corresponding to the corner area of the forming pad 31, is pressed against the corner area of the forming pad 31 by the vacuum pad 36. In addition, the second operation may be an operation (see FIG. 5) in which the forming pad 31 is lowered so that the corner area of the pouch sheet P corresponding to the corner area of the forming pad 31 is elongated.

Through this series of processes, the corner area among the peripheral areas of the pouch sheet P may be elongated intensively.

Referring to FIG. 6, in the second forming process, the punch portion 20 may pressurize the peripheral area and the central area of the pouch sheet P together toward the upper surface of the forming pad 31 while moving to the forming groove S. Since the corner area of the pouch sheet P is elongated for the first time through the first forming process described in FIGS. 4 and 5 and then elongated for the second time through the punch portion 20, it is possible to significantly increase the elongation of the pouch sheet P while preventing cracks or breakage from occurring in the corner area of the pouch sheet P.

Meanwhile, according to an embodiment, the vacuum pad 36 may be continuously brought into close contact with the pouch sheet P even while the punch portion 20 is inserted into the forming groove S to be close to the upper surface of the forming pad 31. For example, the vacuum pad 36 may be continuously brought into close contact with the corner area of the pouch sheet P by continuously applying vacuum pressure or negative pressure throughout the first forming process and the second forming process described above with reference to FIGS. 4 to 6.

As set forth above, a pouch forming apparatus according to an embodiment may significantly reduce occurrence of cracks or breakage of a pouch sheet.

A pouch forming apparatus according to an embodiment may significantly increase the elongation size of a pouch sheet.

A pouch forming apparatus according to an embodiment may manufacture a pouch case with improved energy efficiency.

Only specific examples of implementations of certain embodiments are described. Variations, improvements and enhancements of the disclosed embodiments and other embodiments may be made based on the disclosure of this patent document. In the above-described embodiments, some components may be deleted and implemented, and respective embodiments may be implemented in combination with each other.

The contents described above are merely examples of applying the principles of the present disclosure, and other configurations may be further included without departing from the scope of the present disclosure.

What is claimed is:

1. A pouch forming apparatus comprising:
a die portion having a forming groove;
a punch portion disposed to face the forming groove and configured to move relative to the forming groove, and pressurizing a pouch sheet disposed on the die portion into the forming groove;
a forming pad disposed to move relative to the punch portion within the forming groove and controlling a depth of the forming groove; and
a vacuum pad applying vacuum pressure to the forming groove to be in close contact with the pouch sheet,
wherein the vacuum pad is disposed in at least one corner area of the forming pad.

2. The pouch forming apparatus of claim 1, wherein the forming pad includes a plurality of edge portions and at least one corner portion provided between the plurality of edge portions and disposed in the corner area, and
the vacuum pad is disposed adjacent to the at least one corner portion.

3. The pouch forming apparatus of claim 1, wherein the forming pad divides the forming groove into a first space in which the pouch sheet is disposed and a second space in which the pouch sheet is not disposed, and
the vacuum pad provides vacuum pressure to the first space, to be in close contact with a corner area of the pouch sheet corresponding to a corner area of the vacuum pad.

4. The pouch forming apparatus of claim 1, wherein the vacuum pad and the forming pad each include an upper surface which faces the punch portion and on which the pouch sheet is seated, and
the upper surface of the vacuum pad is disposed parallel to the upper surface of the forming pad or is disposed lower than the upper surface of the forming pad.

5. The pouch forming apparatus of claim 4, wherein the vacuum pad is inserted into the forming pad, to be exposed to the forming groove through the upper surface of the forming pad.

6. The pouch forming apparatus of claim 1, further comprising:
a vacuum device disposed outside the forming groove and forming a vacuum pressure; and
a vacuum line connecting the vacuum device and the vacuum pad and providing the vacuum pressure to the vacuum pad,
wherein the vacuum line penetrates at least one of a forming lower surface or a forming side surface of the die portion forming the forming groove and is connected to the vacuum device.

7. The pouch forming apparatus of claim 2, wherein the forming pad is provided to move so that a relative distance to the punch portion changes while being raised and lowered in the forming groove, and
the vacuum pad is provided to be in close contact with a corner area of the pouch sheet corresponding to the corner area of the forming pad.

8. The pouch forming apparatus of claim 7, wherein the forming pad is provided to elongate the corner area of the pouch sheet while moving in a direction in which the relative distance from the punch portion increases in a state in which the corner area of the pouch sheet and the vacuum pad are in close contact.

9. The pouch forming apparatus of claim 8, wherein the punch portion is provided to bring the pouch sheet into close contact with the forming pad while moving in a direction in which a relative distance from the forming pad decreases in a state in which the corner area of the pouch sheet is extended, and
the vacuum pad is provided to continuously provide vacuum pressure so as to be in close contact with the corner area of the pouch sheet.

10. An apparatus for forming a pouch, comprising:
a die portion having a forming groove and with a pouch sheet disposed thereon;
a punch portion provided to move relative to the forming groove, to be at least partially inserted into the forming groove;
a forming pad provided to be raised and lowered within the forming groove and dividing the forming groove into a first space in which the pouch sheet is introduced and formed and a second space in which the pouch sheet is not introduced, and providing a lower surface of the first space; and
a vacuum pad applying vacuum pressure to the first space so that the pouch sheet is introduced into and adhered to the first space,
wherein the vacuum pad is disposed at a corner area of the forming pad so that the pouch sheet adheres to the corner area of the forming pad, and
the forming pad is provided to elongate the pouch sheet while moving in a direction in which a depth of the first space increases in a state in which the pouch sheet is adhered to the corner area of the forming pad.

11. A method of forming a pouch, comprising:
a first forming process of closely attaching a pouch sheet to a forming pad disposed inside a forming groove and elongating the pouch sheet by lowering the forming pad; and
a second forming process in which a punch portion disposed to face an upper portion of the forming pad is lowered into the forming groove and pressurizes the pouch sheet against the forming pad,
wherein the first forming process includes,
a first operation of pressing the pouch sheet against a corner area of the forming pad by a vacuum pad disposed at the corner area of the forming pad and forming a vacuum pressure; and
a second operation in which the forming pad moves away from the punch portion to elongate a corner area of the pouch sheet corresponding to the corner area of the forming pad.
